(19) United States
(12) Patent Application Publication
(10) Pub. No.: US 2012/0076365 A1
(43) Pub. Date: Mar. 29, 2012

(54) BIOMETRIC KIT AND METHOD OF CREATING THE SAME

(76) Inventor: Matthew T. Schwarz, Davenport, IA (US)

(21) Appl. No.: 13/306,282

(22) Filed: Nov. 29, 2011

Related U.S. Application Data
(63) Continuation-in-part of application No. 12/824,317, filed on Jun. 28, 2010.

(51) Int. Cl. G06K 9/00

(52) U.S. Cl. 382/110

(57) ABSTRACT

A biometric kit and method of using the same that includes the collection and verification of photographs, an animal nose print and DNA profile of a pet or animal along with a specific animal information profile. The collected and verified data is converted to a digital format and stored.

### CROSS REFERENCE TO A RELATED APPLICATION:

This application is a continuation-in-part of U.S. patent application Ser. No. 12/824,317 filed Jun. 28, 2010.

### BACKGROUND OF THE INVENTION

This invention is directed toward the collection and use of biometric information, and more particularly to the creation of a biometric kit for use in the timely identification of individuals.

Organizations, particularly those having a global reach, face difficult and serious issues concerning the safety of employees due to aircraft crashes, natural disasters, kidnapping, and terrorism. In each scenario, based on current practices, it is difficult to properly identify individuals so that they can be returned to next of kin, insurance claims can be processed, and estates can be settled.

In addition, pets and other animals that are valuable to individuals similarly have issues with safety during natural disasters, get lost or wander off and are also hard to find and identify. Furthermore, even without a natural disaster pets such as dogs can get loose and wonder off such that they need to later be identified. To that end, certain animals such as race horses can have insurance contracts on them similar as humans or individuals. In addition, with the importance of breeding rights and stud fees often proof of blood line for championship breeding purposes is desired. Thus, a need in the art exists to be able to also identify animals or pets similar to individuals.

Typically, due to the severity of the accident, there is little information by which to identify a victim as identification documents are missing and due to injuries or decomposition, standard identification methods are not available. Currently, most identification information is gathered after the fact. For example, DNA samples are gathered from toothbrushes, hairbrushes or relatives. A search for fingerprints is conducted from previous background checks or police records. Also, family photos. The reliability of these methods not only is suspect, but also is time consuming sometimes taking months to perform.

Accordingly, there exists a need in the art for a biometric kit and method of using the same that addresses these deficiencies.

An objective of the present invention is to provide a more reliable way to identify the remains of an individual.

These and other objectives will be apparent to one skilled in the art based upon the following disclosure.

### SUMMARY OF THE INVENTION

A biometric kit and method of using the same includes the collection and verification of photographs, animal nose prints, DNA profile, and dental radiographs of an individual along with an information profile about the animal. The collected and verified data is converted to a digital format and stored.

### BRIEF DESCRIPTION OF THE DRAWINGS

FIG. 1 is a schematic drawing of the environment of a biometric kit; and

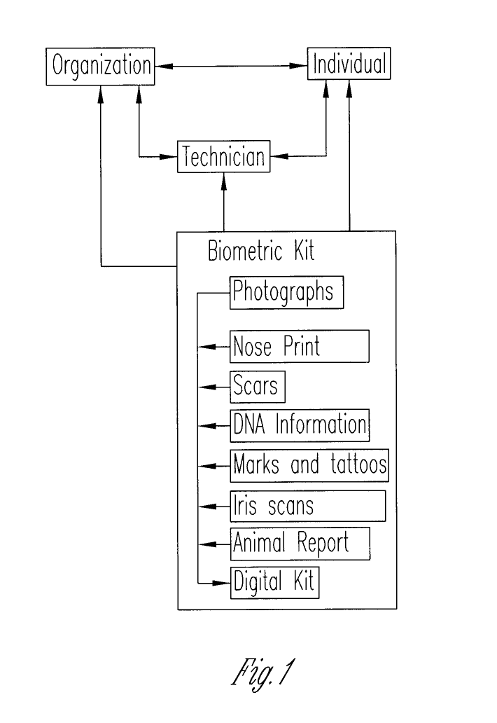

FIG. 2 is a flow diagram of a method of creating a biometric kit.

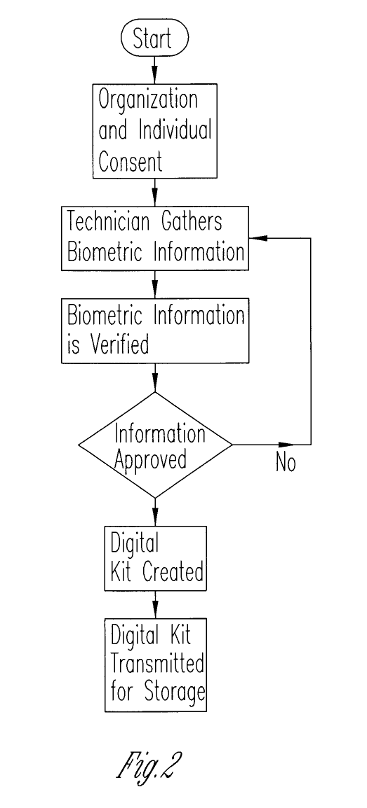

### DETAILED DESCRIPTION OF THE PREFERRED EMBODIMENTS

Referring to the Figures, the biometric kit includes photographs 12, a nose print 14 of an animal, a DNA profile 16, a dental radiograph 18, and a record of personal information 20. Alternatively, when attempting to identify an animal the personal information 20 in the kit contains information specific to the animal including information such as dog tags.

The photographs 12 include both facial 22 and identifiers 24 such as scars, marks, tattoos, iris coloring, coloring patterns and the like. Preferably the facial photographs 22 will include a frontal, left and right side with a name tag and scale. These photographs will be taken in RAW format to maximize the information contained in each image and allow for subsequent forensic use of the image. Photos will be taken in accordance with the standards promulgated by the American National Institute of Standards and Technology. All photographs will be suitable for use with state of the art photo recognition software. Identifier photographs 24 will be taken with a name tag and scale. In addition, all identifying marks will be documented and charted by a technician 26.

Nose prints 14 include information specific to a certain animal. For example nose print cards, inked impression of the nose, a powder and adhesive lift method and the like can be used to make an animal's nose print 14. Other similar methods can be used to identify a particular animal or pet.

The DNA profile 16 includes a buccal swab taken from the individual's or animal's mouth or blood. The swab is sent to a DNA lab for a profile to be developed and included in the kit. For individuals, the DNA profile is designed to remove human genome information so the profile cannot be used for identification of future medical issues. The swab is destroyed during processing and only the DNA profile will be retained in a written, PDF or similar format for easy storage.

The dental radiograph 18 is obtained from the individual's dentist or will be taken by a technician. Preferred is an x-ray of the whole mouth. From the x-rays and dental records a 1-32 standard dental mapping is included in the written records. The x-rays and written record are converted to an electronic file.

Finally, the record of personal or animal information 20 that in the human embodiment is based upon the Victim

Identification Profile shown in the National Association of Medical Examination Mass Fatality Plan. Included is information from a survey completed by the individual with duress/identification codes used in kidnapping scenarios and identification information and serial numbers for medical devices such as pacemakers or artificial joints.

In operation, initially the organization and the individual consent to having a kit 10 prepared for themselves or an animal. Once consent is received a technician 26 meets with the individual or sees the animal and collects the biometric information and personal/animal specific information. Once collected, the biometric/forensic data is verified by a subject matter expert. For example, a certified latent print examiner checks all friction ridge detail to ensure suitability for identification. Any questionable impressions will be retaken. Similarly, a board certified and licensed dentist will verify the suitability of all radiographs. Further, all documents generated during the information gathering process will have a thumbprint of the subject to guarantee reliability and accuracy of the information generated.

Once the information is gathered from the individual or animal, the information is converted into a digital format. High resolution scans are made of all friction ridge skin and the documents generated during collection. Lower resolution copies are also prepared in the event the kit needs to be e-mailed. Preferably the digital kit is encrypted and recorded to archival quality optical and/or magnetic media.

Once the digital kit is created it is transmitted over an electronic network for storage. Depending on the consent, the digital kit is stored by the organization, the individual, and/or the technician. Physical items such as silicone casts are placed in archival quality storage containers.

Accordingly, a biometric kit has been disclosed that at the very least meets the stated objectives.

What is claimed is:

1. A biometric kit, comprising:
photographs of an animal's face and identifying marks;
a DNA profile; and
an information record wherein the photographs, DNA profile and information record are stored in a digital format.

2. The biometric kit of claim 1 further comprising a nose print of the animal.

3. The biometric kit of claim 2 wherein the nose print of the animal is stored in a digital format.
